(19) United States
(12) Patent Application Publication
(10) Pub. No.: US 2003/0047293 A1
(43) Pub. Date: Mar. 13, 2003

(54) Door leaf of a collapsible door

(76) Inventor: Chen-Hsiang Lee, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/948,681

(22) Filed: Sep. 10, 2001

(51) Int. Cl. E06B 3/12

(52) U.S. Cl. 160/236

(57) ABSTRACT

A door leaf for a collapsible door comprises two parallel side plates defining a space therebetween, each of the side plates comprising a mounting groove in an inner side thereof for receiving one of two lateral edges of a decorative panel. A positioning plate is mounted between the side plates and comprises a slide strip on each of two lateral sides thereof, each of the slide strips being configured to be slidable along the mounting groove of an associated one of the side plates. A transverse member is securely attached to an inner end of the positioning plate and comprises an insertion groove for receiving an end of the decorative panel. In another embodiment, the space between the side plates is separated by a transverse member into two subspaces for receiving two decorative panels.

### BACKGROUND OF THE INVENTION

1. Field of the Invention

The present invention relates to a door leaf of a collapsible door that can be easily processed and quickly assembled.

2. Description of the Related Art

A collapsible door is used in separation of an indoor space and typically comprises plural door leaves that are hinged one by one. FIGS. 1 and 2 of the drawings illustrate a conventional door leaf having decorative panels embedded therein. This conventional door leaf comprises two parallel side plates 11, at least one decorative panel 10 mounted between the side plates 11, and upper and lower positioning plates 12 mounted between the side plates 11 and respectively on two ends of the decorative panel 10. Each side plate 11 has a mounting groove 111 in an inner side thereof for slidably receiving an associated lateral side of the decorative panel 10. Each side plate 11 further has a pivot 112 provided on an outer side thereof for pivotal engagement with another door leaf via a coupling means (not shown). Each positioning plate 12 comprises a slide strip 121 provided on each of two lateral sides thereof so as to be slidably received in an associated mounting groove 111. Each positioning plate 12 further has an insertion groove 122 in an inner end thereof for fittingly receiving an associated end of the decorative panel 10.

In order to provide a light structure, the side plates 11 and the positioning plates 12 are formed of polyvinyl chloride by extrusion, so as to provide a longitudinal space, and ribs 15 are provided in the longitudinal space to reinforce the structure. However, it is impossible to form the insertion groove 122 in the positioning plate 12 during the extrusion of the positioning plate 12 having two lateral slide strips 121. Currently, an end of the positioning plate 12 is milled to form a recessed portion 120, and a substantially U-shaped end plate 14 is bonded or fixed by screws to the recessed portion 120 so as to provide an insertion groove 122 in the positioning plate 12 for mounting the decorative panel 10, as shown in FIG. 3. However, this is troublesome, time-consuming, and labor-intensive. In addition, it is common to apply a wood-imitating sheet on the door leaf, but the wood-imitating sheet could not cover the area of the insertion groove 122 of the positioning plate 12. The overall aesthetic pleasing effect is greatly, adversely affected. Further, the positioning plates 12 and the side plates 11 must have tight, fitting engagement therebetween in order to prevent relative swaying motions therebetween. However, it is not uncommon that the positioning plates 12 and the side plates 11 cannot be engaged with each other due to tolerance.

### SUMMARY OF THE INVENTION

It is, therefore, an object of the present invention to provide a door leaf of a collapsible door that can be easily processed and quickly assembled.

Another object of the present invention is to provide a door leaf of a collapsible door having diverse combinations in the decorative panels mounted in the door leaf.

In accordance with a first aspect of the invention, a door leaf for a collapsible door comprises two parallel side plates defining a space therebetween, each of the side plates comprising a mounting groove in an inner side thereof for receiving one of two lateral edges of a decorative panel. A positioning plate is mounted between the side plates and comprises a slide strip on each of two lateral sides thereof, each of the slide strips being configured to be slidable along the mounting groove of an associated one of the side plates. A transverse member is securely attached to an inner end of the positioning plate and comprises an insertion groove for receiving an end of the decorative panel.

The transverse member comprises a second insertion groove opposite to the insertion groove receiving the end of the decorative panel. A connecting member is securely attached to the inner end of the positioning plate. The connecting member is releasably engaged with the second insertion groove of the transverse member. The connecting member has a guide element that is configured to be slidable along a longitudinal direction of the second insertion groove of the transverse member and to prevent disengagement of the guide element from the second insertion groove of the transverse member along a direction orthogonal to the longitudinal direction of the second insertion groove.

The transverse member is obtained by means of cutting from one of the side plates. This saves the cost for the molds for manufacturing the parts of the door leaf.

In accordance with a second aspect of the invention, a door leaf for a collapsible door comprises two parallel side plates defining a space therebetween, each of the side plates comprising a mounting groove in an inner side thereof. A transverse member mounted between the side plates and slidable along a longitudinal direction of the side plates for dividing the space into two subspaces each for receiving a panel that has two lateral sides respectively received in the mounting grooves of the side plates, the transverse member comprising a first insertion groove and a second insertion groove each for receiving an end of a respective said panel.

A slide guide is attached to each of two lateral sides of the transverse member and configured to be slidable along a longitudinal direction of the mounting groove of a respective said side plate and to prevent disengagement of the slide guide from the mounting groove of the respective side plate along a direction orthogonal to the longitudinal direction of the mounting groove.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a conventional door leaf of a collapsible door.

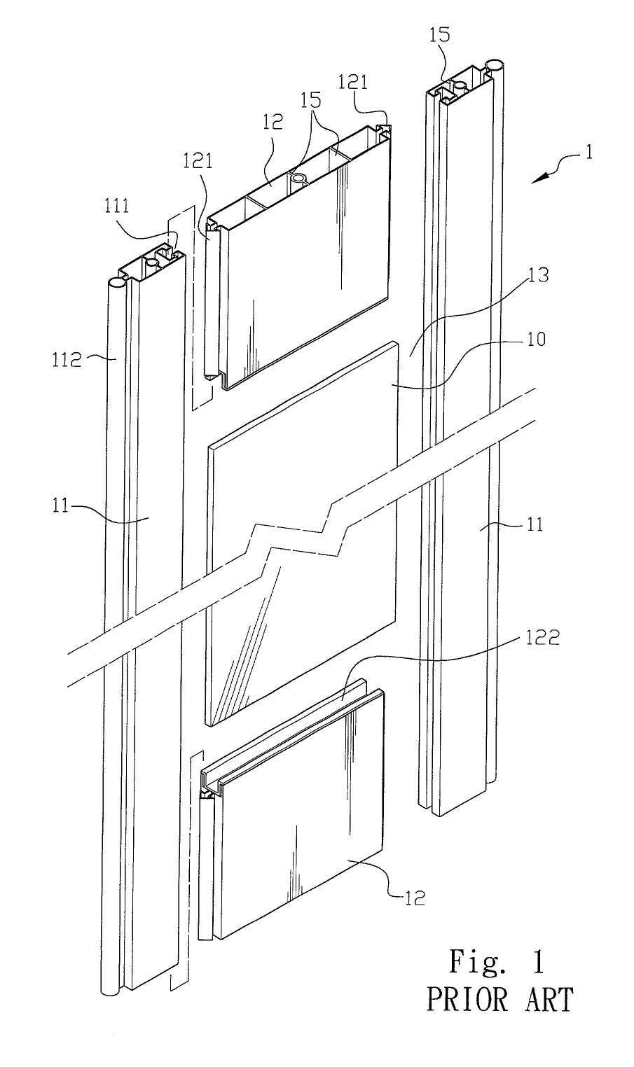

FIG. 2 is a perspective view of the conventional door leaf in FIG. 1.

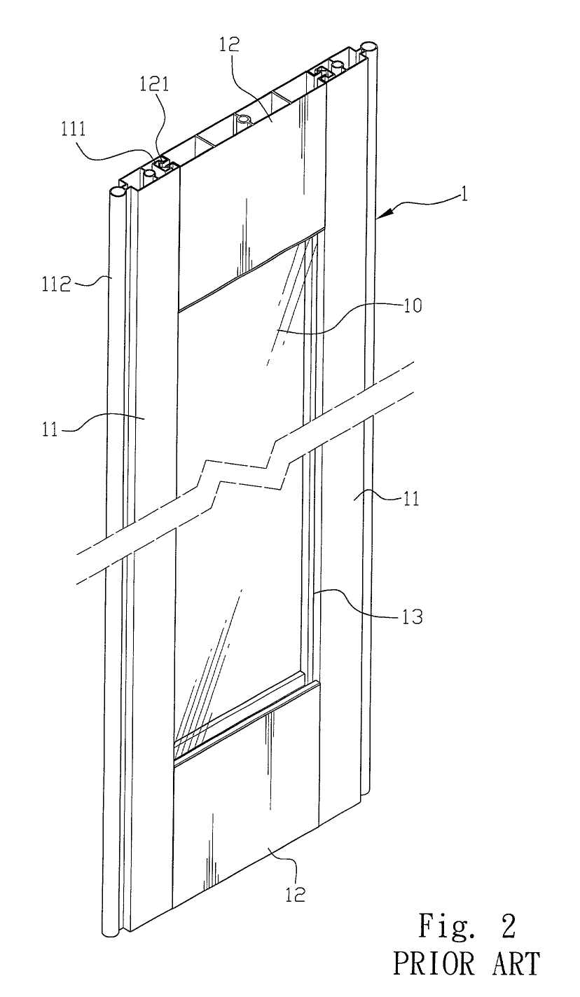

FIG. 3 is an exploded perspective view of a positioning plate of the conventional door leaf in FIG. 1.

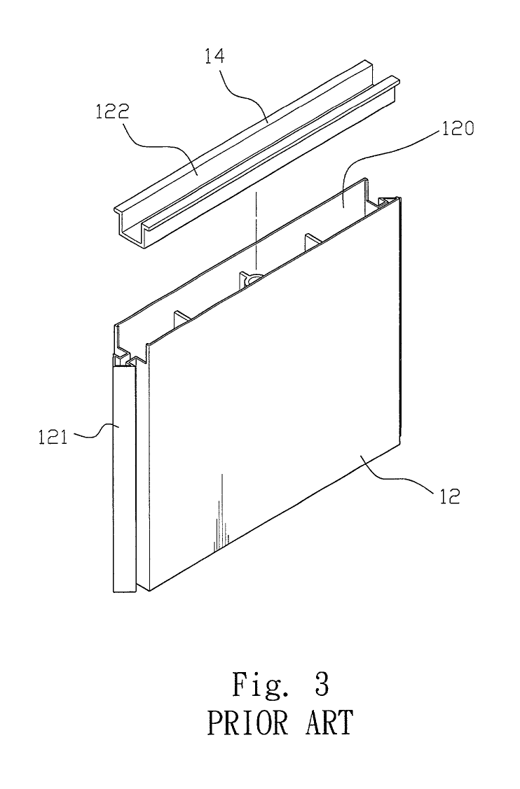

FIG. 4 is an exploded perspective view of a door leaf of a collapsible door in accordance with the present invention.

FIG. 5 is a perspective view of the door leaf in FIG. 4.

FIG. 6 is a perspective view of a modified embodiment of a positioning plate of the door leaf in accordance with the present invention.

FIG. 7 is an exploded perspective view illustrating another embodiment of the door leaf in accordance with the present invention.

FIG. 8 is an exploded perspective view illustrating a further embodiment of the door leaf in accordance with the present invention.

FIG. 9 is an exploded perspective view illustrating still another embodiment of the door leaf in accordance with the present invention.

FIG. 10 is an exploded perspective view of a transverse member of the door leaf in FIG. 7.

### DETAILED DESCRIPTION OF THE PREFERRED EMBODIMENTS

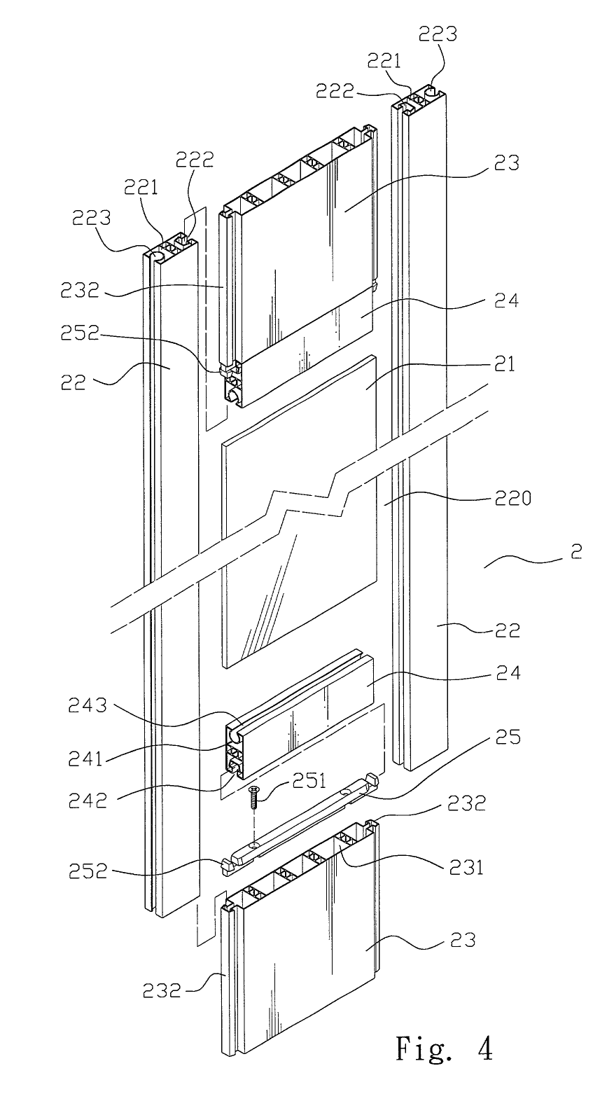

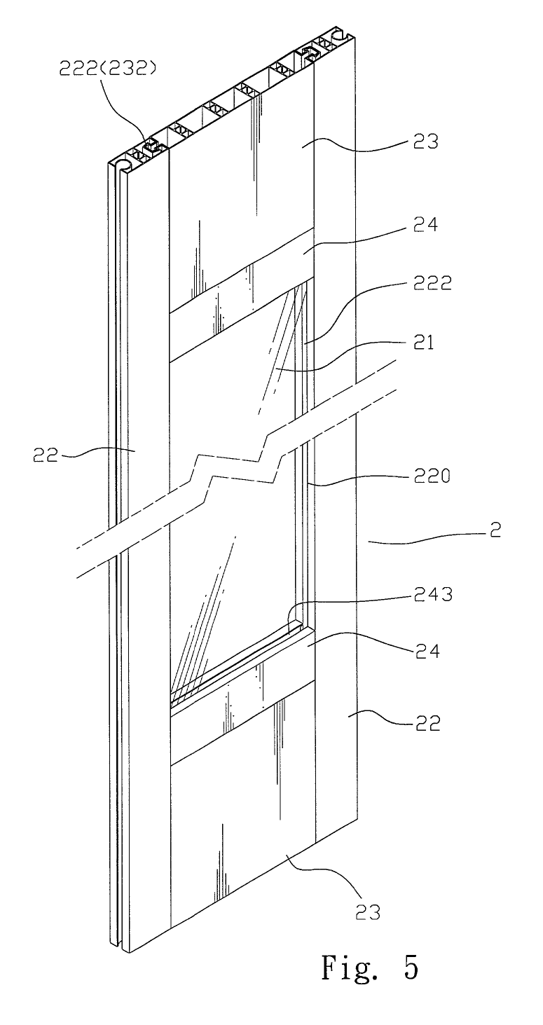

Referring to FIGS. 4 through 10 and initially to FIGS. 4 and 5, a door leaf 2 for a collapsible door in accordance with the present invention generally comprises two parallel side plates 22 defining a space 220 therebetween for mounting at least one decorative panel 21. Each side plate 22 is formed by extrusion to provide a longitudinal space, and ribs 221 are provided in the longitudinal space to reinforce the structure. Each side plate 22 further has a first mounting groove 222 in an inner side thereof and a second mounting groove 223 in an outer side thereof. The second mounting groove 223 of the side plate 22 of the door leaf 2 is configured to pivotally engage with a side plate (not shown) of another door leaf (not shown) via a coupling means (not shown). However, it is noted that the side plates 22 of the door leaf 2 can be configured to directly, pivotally engage with those of another door leaf without any coupling means.

The door leaf 2 in accordance with the present invention further comprises at least one positioning plate 23 mounted between the side plates 21. In this embodiment, there are two positioning plates 23 each of which is formed by extrusion to provide a longitudinal space, and ribs 231 are provided in the longitudinal space to reinforce the structure. Each positioning plate 23 further has a slide strip 232 on each of two lateral sides thereof.

Each positioning plate 23 further has a transverse member 24 attached to an inner end thereof. Each transverse member 24 is formed by extrusion to provide a longitudinal space, and ribs 241 are provided in the longitudinal space to reinforce the structure. Each transverse member 24 comprises a first insertion groove 243 in an inner longitudinal side thereof and a second insertion groove 242 in an outer longitudinal side thereof As illustrated in FIG. 4, a connecting member 251 is securely attached by screws 251 to an inner end of each positioning plate 23 and includes two guide elements 252 respectively on two ends thereof. Each transverse member 24 is attached to a respective positioning plate 23 by means of engaging the second insertion groove 242 with the connecting member 25 on the respective positioning member 23 along a longitudinal direction of the connecting member 25. Each guide element 252 is configured to be slidable along the longitudinal direction of the second insertion groove 242 of the respective transverse member 24 and to prevent disengagement of the guide element 252 from the second insertion groove 242 of the respective transverse member 24 along a direction orthogonal to the longitudinal direction of the second insertion groove 242.

In assembly, upper and lower ends of the decorative panel 21 are respectively inserted into the first insertion grooves 243 of the upper and lower transverse members 24. Next, the mounting grooves 222 of the side plates 22 are engaged with the slide strips 232 of the upper positioning plate 23, two lateral edges of the decorative panel 21, and the slide strips 232 of the lower positioning plate 23. Thus, a door leaf 2 of a collapsible door is finished, as shown in FIG. 5. Assembly of such a door leaf can be easily and quickly achieved. A wood-imitating sheet may be applied to the outer surface area of the side plates 22, the transverse members 24, and the positioning plates 23 of the door leaf 2 to thereby provide an aesthetically pleasing effect, as the two ends of each of the positioning members 23 and the transverse members 24 are flush. Further, in order to allow convenient manufacture, the transverse member 24 can be directly cut from the slide strip 22, and it is noted that the second insertion groove 242 of the transverse member 24 is identical to the first mounting groove 222 of the side plate 22 while the first insertion groove 243 of the transverse member 24 is identical to the second mounting groove 223 of the side plate 22. The manufacturer may use only two kinds of molds: one for producing the side plates 22 and the transverse members 24, and the other for producing the positioning plates 23. The cost for the molds is thus reduced. It is noted that one of the positioning plates 23 may be replaced by other plate for receiving an end of the decorative plate 21.

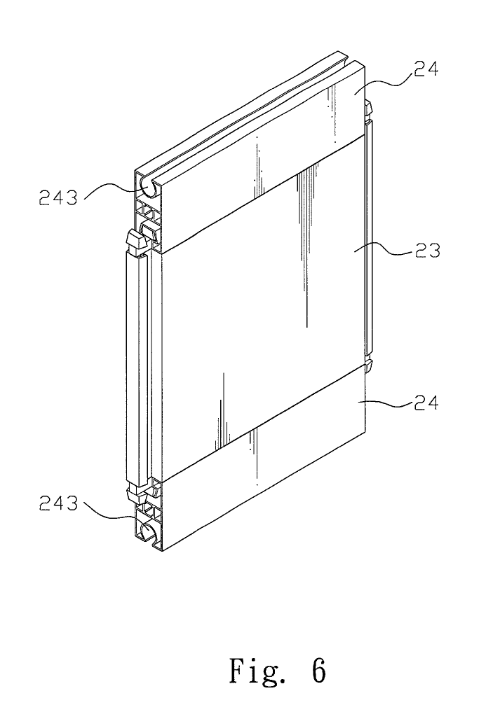

FIG. 6 illustrates a modified embodiment of the positioning plate 23 having two transverse members 24 securely attached to inner and outer ends thereof. Such a positioning plate 23 can be mounted between two decorative panels 21 mounted in the space between the side plates 22.

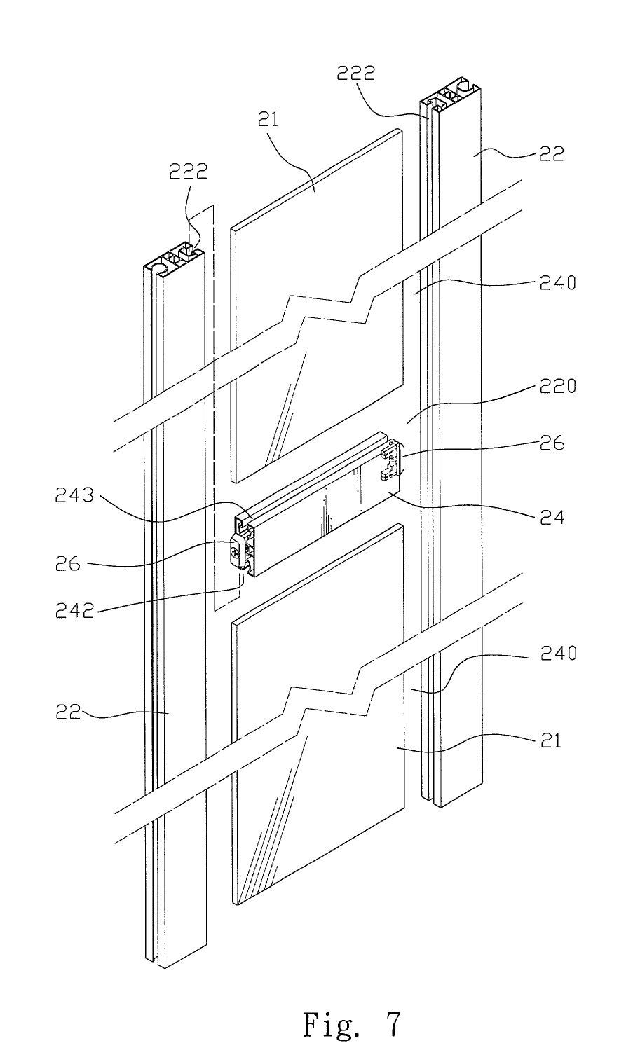

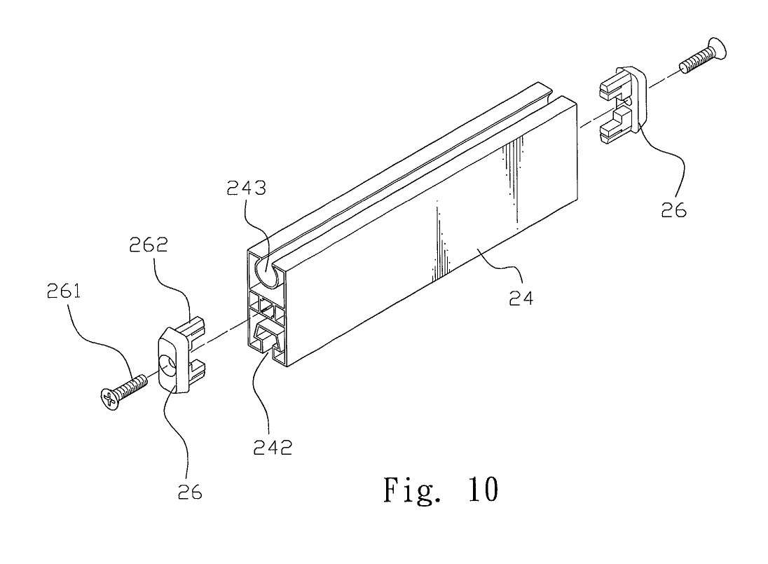

FIG. 7 illustrates another embodiment of the door leaf in accordance with the present invention. The door leaf comprises two side plates 22 defining a space 220 therebetween for receiving at least two decorative panels 21 that is separated by a transverse member 24 into two subspaces. The side plates 22 are identical to that disclosed in the first embodiment. The transverse member 24 comprises a first insertion groove 243 in an inner longitudinal side thereof and a second insertion groove 242 in an outer longitudinal side thereof. In addition, a slide guide 26 is securely attached by, e.g., a screw 261 (FIG. 10) to each of two lateral sides of the transverse member 24. The slide guide 26 is configured to be slidable along the longitudinal direction of the first mounting groove 222 of the respective side plate 22 and to prevent disengagement of the slide guide 26 from the first mounting groove 222 of the respective side plate 22 along a direction orthogonal to the longitudinal direction of the first mounting groove 222. Thus, plural decorative panels 21 of different sizes can be mounted between the side plates 22 by means of diverse combinations of plural transverse members 24 and the decorative panels 21, thereby providing diverse choices for decorative purpose. FIG. 10 illustrates detailed structure of the transverse member 24 in FIG. 7, in which each slide guide 26 has two legs 262 that are engaged with a side of the transverse member 24. Of course, one of the legs 262 may be securely engaged with one of the insertion grooves 242 and 243.

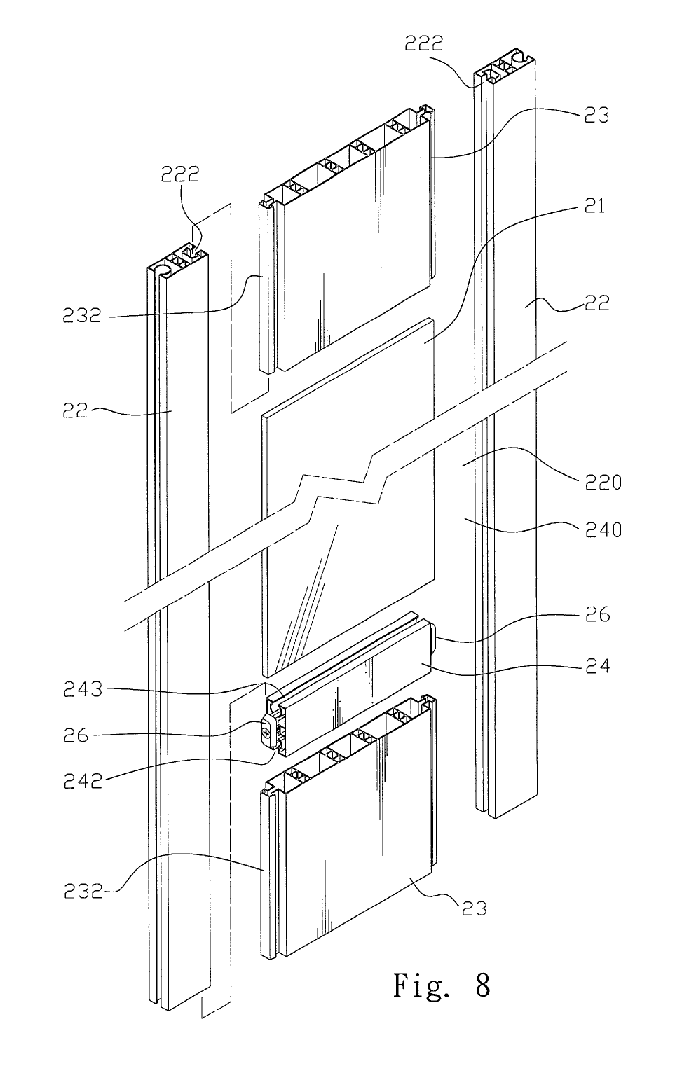

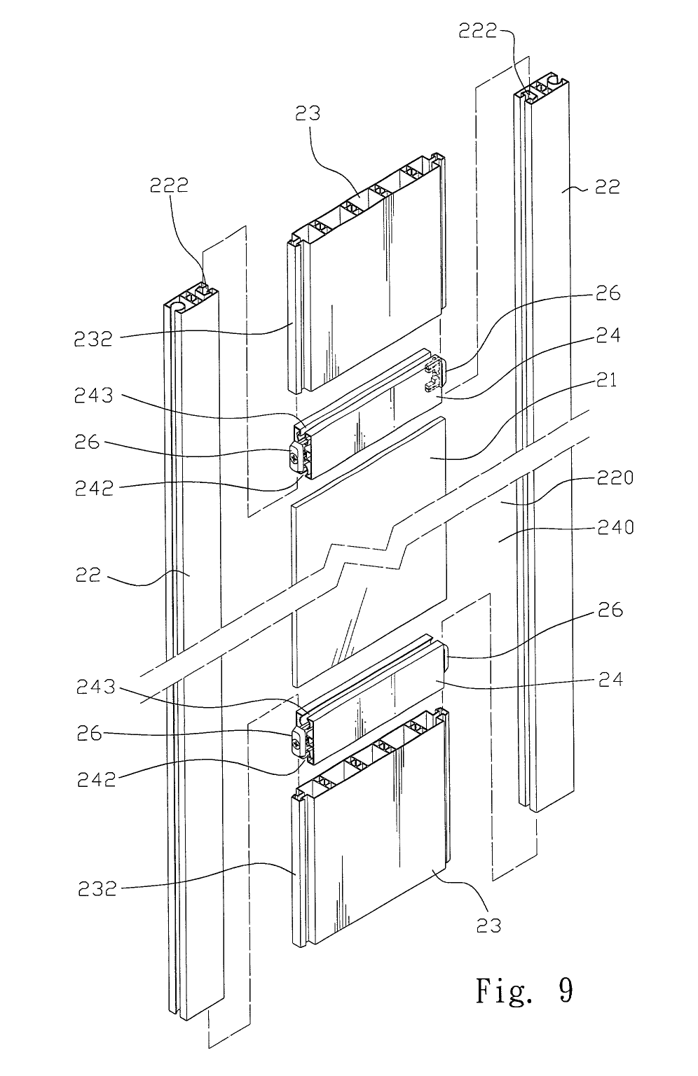

FIG. 8 illustrates a modified embodiment of the door leaf comprised of two side plates 22, two positioning plates 23, a transverse member 24 shown in FIG. 10, and a decorative panel 21. FIG. 9 illustrates another modified embodiment of the door leaf comprised of two side plates 22, two positioning plates 23, two transverse members 24 shown in FIG. 10, and a decorative panel 21 mounted between the transverse members 24.

By means of diverse combinations of the decorative panel(s) 21, positioning plates 23, and the transverse members 24, it is possible to provide a wide variety of door leaves of different designs for decorative purpose without increasing the cost for the molds.

Although the invention has been explained in relation to its preferred embodiment, it is to be understood that many other possible modifications and variations can be made without departing from the scope of the invention as hereinafter claimed.

What is claimed is:

1. A door leaf for a collapsible door, comprising:
two parallel side plates defining a space therebetween, each of the side plates comprising a mounting groove in an inner side thereof for receiving one of two lateral edges of a decorative panel;
a positioning plate mounted between the side plates, the positioning plate comprising a slide strip on each of two lateral sides thereof, each of the slide strips being configured to be slidable along the mounting groove of an associated one of the side plates; and
a transverse member securely attached to an inner end of the positioning plate, the transverse member comprising an insertion groove for receiving an end of the decorative panel.

2. The door leaf as claimed in claim 1, wherein the transverse member comprises a second insertion groove opposite to the insertion groove receiving the end of the decorative panel, further comprising a connecting member securely attached to the inner end of the positioning plate, the connecting member being releasably engaged with the second insertion groove of the transverse member.

3. The door leaf as claimed in claim 2, wherein the connecting member has a guide element that is configured to be slidable along a longitudinal direction of the second insertion groove of the transverse member and to prevent disengagement of the guide element from the second insertion groove of the transverse member along a direction orthogonal to the longitudinal direction of the second insertion groove.

4. The door leaf as claimed in claim 1, wherein the transverse member is obtained by means of cutting from one of the side plates.

5. The door leaf as claimed in claim 1, further comprising means for retaining another end of the decorative panel in place.

6. The door leaf as claimed in claim 1, further comprising another said positioning plate mounted between the side plates for retaining another end of the decorative panel in place.

7. A door leaf for a collapsible door, comprising:
two parallel side plates defining a space therebetween, each of the side plates comprising a mounting groove in an inner side thereof; and
a transverse member mounted between the side plates and slidable along a longitudinal direction of the side plates for dividing the space into two subspaces each for receiving a panel that has two lateral sides respectively received in the mounting grooves of the side plates, the transverse member comprising a first insertion groove and a second insertion groove each for receiving an end of a respective said panel.

8. The door leaf as claimed in claim 7, wherein the transverse member has two lateral sides, a slide guide being attached to each of the lateral sides of the transverse member and configured to be slidable along a longitudinal direction of the mounting groove of a respective said side plate and to prevent disengagement of the slide guide from the mounting groove of the respective side plate along a direction orthogonal to the longitudinal direction of the mounting groove.

9. The door leaf as claimed in claim 7, wherein the transverse member is obtained by means of cutting from one of the side plates.
